(19) United States
(12) Patent Application Publication
(10) Pub. No.: US 2011/0076544 A1
(43) Pub. Date: Mar. 31, 2011

(54) STACK TYPE BATTERY

(75) Inventors: Hitoshi Maeda, Kobe-shi (JP); Yoshitaka Shinyashiki, Kobe-shi (JP); Masayuki Fujiwara, Kasai-shi (JP); Atsuhiro Funahashi, Osaka (JP)

(73) Assignee: SANYO ELECTRIC CO., LTD., Osaka (JP)

(21) Appl. No.: 12/893,768

(22) Filed: Sep. 29, 2010

(30) Foreign Application Priority Data
Sep. 30, 2009 (JP) 2009-226516

(51) Int. Cl. H01M 2/18

(52) U.S. Cl. 429/136

(57) ABSTRACT

A stack type battery has a plurality of positive electrode plates (1) and a plurality of negative electrode plates (2), which are alternately stacked one on the other with separators (3) interposed therebetween. It also has positive electrode leads (11) and negative electrode leads (12) protruding from the respective electrode plates (1, 2) and being stacked and joined to a positive electrode current collector terminal (15) and a negative electrode current collector terminal (16), respectively. Peripheral portions of the separators that face each other across each of the positive electrode plates (1) are welded to form a pouch-type separator (3), and the positive electrode leads (11) are joined to each other at weld points (31W) in a region thereof facing the separator (3).

### FIELD OF THE INVENTION

The present invention relates to stack type batteries, and more particularly to stack type lithium-ion batteries having high capacity and high-rate capability that are used for, for example, robots, electric vehicles, and backup power sources.

### DESCRIPTION OF RELATED ART

In recent years, batteries have been used for not only the power source of mobile information terminal devices such as mobile-phones, notebook computers, and PDAs but also for such applications as robots, electric vehicles, and backup power sources. This has led to a demand for higher capacity batteries. Because of their high energy density and high capacity, lithium-ion batteries are widely used as the power sources for such applications as described above.

The battery configurations of the lithium-ion batteries are broadly grouped into two types: a spirally-wound type lithium-ion battery, in which a spirally wound electrode assembly is enclosed in a battery case, and a stack type lithium-ion battery (stack-type prismatic lithium ion battery), in which a stacked electrode assembly comprising a plurality of stacks of rectangular-shaped electrodes is enclosed in a battery case or a laminate battery case prepared by welding laminate films together.

Of the above-described lithium ion secondary batteries, the stack type lithium-ion battery has the following structure. A stacked electrode assembly is enclosed in a laminate battery case. The stacked electrode assembly has a required number of sheet-shaped positive electrode plates each having a positive electrode current collector lead and a required number of sheet-shaped negative electrode plates each having a negative electrode current collector lead protruding therefrom. The positive electrode plates and the negative electrode plates are stacked with separators interposed between the positive and negative electrode plates.

In addition, the following structure may be employed. Peripheral portions of separators are thermally welded into a pouch shape while each of the positive electrode plates is sandwiched between the separators, in order to avoid dislocation of the positive electrode plates and the negative electrode plates outside the separators. This prevents the positive electrode plates and the negative electrode plates from making contact with each other and causing a short circuit.

However, since the positive and negative electrode current collector leads protrude from the positive and negative electrode plates, the peripheral portion of the separator that covers the protruding portion of the positive or negative electrode current collector lead cannot be welded. Therefore, it is inevitable that an unwelded portion of the separator is formed at that portion. In this structure of pouch-type separator, the separator shrinks on heating. When heat is applied to the separator by an abnormal reaction or the like, the welded portion of the separator stops shrinking by engaging with the outer peripheral edge of the positive electrode plate. However, the unwelded portion of the separator near the positive electrode current collector lead shrinks easily, causing the positive electrode current collector lead and the negative electrode plate to come into contact with each other and resulting in a short circuit.

If, for example, the separator is provided with an extra margin for allowing the unwelded portion of the separator to undergo the thermal shrinkage as described above, it may be possible to prevent the short circuit resulting from the contact between the positive electrode current collector lead and the negative electrode plate. However, this increases the size of the separator correspondingly, and consequently, the volumetric energy density of the battery decreases.

In view of the problem, PCT Publication WO 2006/095579 discloses that a short circuit resulting from dislocation of separators and electrode plates is prevented by forming a cut in each of the electrode plates and thermally bonding opposing regions of the separators to each other through the cut.

However, a problem with the structure disclosed in PCT Publication WO 2006/095579 is that the formation of the cut decreases the cross-sectional area of the electrode plate lead and consequently increases the internal resistance, and therefore the rate performance becomes poor.

Accordingly, it is an object of the present invention to provide a stack type battery that can effectively inhibit the short circuit resulting from the thermal shrinkage of the separator without reducing the volumetric energy density of the battery or increasing the internal resistance.

In order to accomplish the foregoing and other objects, the present invention provides a stack type battery comprising:

a plurality of positive electrode plates each having a positive electrode lead protruding therefrom; a plurality of negative electrode plates each having a negative electrode lead protruding therefrom; a plurality of separators; a positive electrode current collector terminal; and a negative electrode current collector terminal, the positive and negative electrode plates being alternately stacked one on the other with the separators interposed therebetween, and the positive electrode leads and the negative electrode leads being stacked and joined respectively to the positive electrode current collector terminal and the negative electrode current collector terminal, wherein:

peripheral portions of the separators that face each other across each of the positive electrode plates are firmly bonded to each other at least a portion of each of the peripheral portions to form a pouch-shaped separator; and

the positive electrode leads are joined to each other in a region in which each of the positive electrode leads and each of the separators face each other (the region hereinafter also referred to as a “separator facing region”).

In the present invention, the term “pouch-type separator” is meant to include any type of separator that can hold a positive electrode plate between a pair of the separators. For example, in the case of square-shaped separator, it includes not only one in which separators are firmly bonded to each other at each of their three or four sides linearly to form a pouch but also one in which separators are firmly bonded to each other at least one point in each of their three or four sides.

With the above-described configuration of the present invention, if the separator undergoes thermal shrinkage near the positive electrode leads, the separator engages with the joined part of the positive electrode leads and the shrinkage stops because the positive electrode leads are joined to each other in the separator facing region. As a result, the short circuit resulting from the contacting between the positive electrode leads and the negative electrode plates can be prevented effectively. Moreover, this can be achieved by merely joining the positive electrode leads to each other in the separator facing region. Therefore, the actual size of the separator is not increased, and the cross-sectional area of the positive electrode lead is not reduced. As a result, the volumetric energy density of the battery is not reduced, and the internal resistance is not increased either. Thus, a mechanism for effectively preventing a short circuit between the positive electrode leads and the negative electrode plates with a simple configuration can be provided easily.

It is desirable that each of the separators have a penetrating portion provided in a region thereof facing the positive electrode leads (hereinafter also referred to as a “lead facing region”), and that the positive electrode leads be joined to each other at the penetrating portion.

It may be possible to join the positive electrode leads to each other together with the separator in the separator facing region by using, for example, laser welding (i.e., the separator is joined while being melted). However, by providing the penetrating portion in the separator and joining the positive electrode leads to each other at the penetrating portion as described above, the positive electrode leads can be joined to each other without interposing the separator partially in the area of the separator facing region, so ultrasonic welding or the like can be used for the joining.

As the method of joining the positive electrode leads, it is possible to employ resistance welding or the like, other than the laser welding and the ultrasonic welding. Moreover, other than welding, it is also possible to employ a method in which the components to be joined are mechanically joined, such as screw-fastening as well as swaging and thrust-and-press clamping, in which the components to be joined are deformed. Although these mechanical methods offer additional advantages that the joining work can be performed with a simple facility and accordingly the fabrication of the battery can be performed more easily and at lower cost, welding is more desirable because the resistance can be made more uniform. In particular, ultrasonic welding can provide high welding strength and good weldability.

It is desirable that the positive electrode leads be joined to each other in a region in which each of the positive electrode leads and each of the separators face each other (i.e., a separator facing region), the region being different from a region in which the plurality of the positive electrode leads are stacked and joined to the positive electrode current collector terminal.

Generally, the number of the stacks in the stack type battery has been increased in order to obtain higher capacity, and the current collector terminals have been made thicker in order to pass larger current. This means that a large number of electrode plate leads each made of a metal foil needs to be joined to a current collector terminal made of a thick metal plate. In this case, the joined part between the metal foils and the metal plate tends to have poorer weldability than the joined part between the metal foils because of the thickness difference. When the weldability becomes poor, the connection resistance between each of the electrode plates and the current collector terminal becomes non-uniform, causing variations in the current values flowing into the respective electrode plates especially when used at high rate. As a consequence, uneven charge-discharge states arise and overdischarge and overcharge occur locally in the battery, deteriorating the cycle performance.

In view of the problem, it is possible to inhibit the variations in the resistance values in the connection portions between the electrode plates and the current collector terminal by joining and electrically connecting the electrode plate leads to each other at a different location from the connection portion with the current collector terminal. This connection structure of the electrode plate leads has been published in Japanese Published Unexamined Patent Application No. 2009-87611, which is assigned to the assignee of the present invention.

By allowing the joining of the electrode plate leads to each other as in the just-mentioned known structure to be within the separator facing region of the positive electrode lead as described above, the present invention inhibits variations in the resistance values of the connection portions between the positive electrode plates and the positive electrode current collector terminal, and at the same time, it effectively prevents the short circuit resulting from the contact between the positive electrode leads and the negative electrode plates. In other words, by joining only the positive electrode leads in the separator facing region, the present invention achieves both the effect of prevention of the short circuit between the positive electrode leads and the negative electrode plates and the effect of uniformization of the resistance values of the connection portions between the positive electrode plates and the positive electrode current collector terminal.

It is desirable that the stack type battery be a lithium-ion battery.

When constructing a lithium-ion battery with a high energy density by the stack type battery, the number of stacks tends to be greater in order to further increase the capacity. When the number of the stacks is greater, variations in the connection resistance tend to occur more easily. Therefore, the advantageous effects obtained by joining only the positive electrode leads each other in the separator facing region can be exhibited more effectively.

It is desirable that the number of the positive electrode plates stacked be 30 or greater.

When the number of the positive electrode plates stacked is 30 or greater, the weldability of the joining portion of the current collector terminal and the positive electrode leads tends to be poorer, so the advantageous effects obtained by joining only the positive electrode leads each other in the separator facing region will be more significant.

According to the present invention, it becomes possible to effectively inhibit the short circuit resulting from the thermal shrinkage of the separator without decreasing the volumetric energy density or increasing the internal resistance of the battery.

### BRIEF DESCRIPTION OF THE DRAWINGS

FIG. 1 shows portions of a stack type battery according to the present invention, wherein FIG. 1(a) is a plan view illustrating a positive electrode thereof, FIG. 1(b) is a perspective view illustrating a separator thereof, and FIG. 1(c) is a plan view illustrating a pouch-type separator thereof in which the positive electrode is disposed;

FIG. 2 is a plan view illustrating a negative electrode plate used for the stack type battery according to the present invention;

FIG. 3 is an enlarged view illustrating a portion of a pouch-type separator, near the positive electrode lead, that accommodates a positive electrode plate used for the stack type battery according to the present invention;

FIG. 4 is an exploded perspective view illustrating a stacked electrode assembly used for the stack type battery according to the present invention;

FIG. 5 is a plan view illustrating the stacked electrode assembly used for the stack type battery according to the present invention;

FIG. 6 is a plan view illustrating how the positive and negative electrode leads and the positive and negative electrode current collector terminals are welded together; and

FIG. 7 is a perspective view illustrating the stack type battery according to the present invention.

### DETAILED DESCRIPTION OF THE INVENTION

Hereinbelow, embodiments of the stack type battery according to the present invention are described in detail. It should be construed, however, that the stack type battery according to this invention is not limited to the following embodiments and examples but various changes and modifications are possible without departing from the scope of the invention.

### Preparation of Positive Electrode

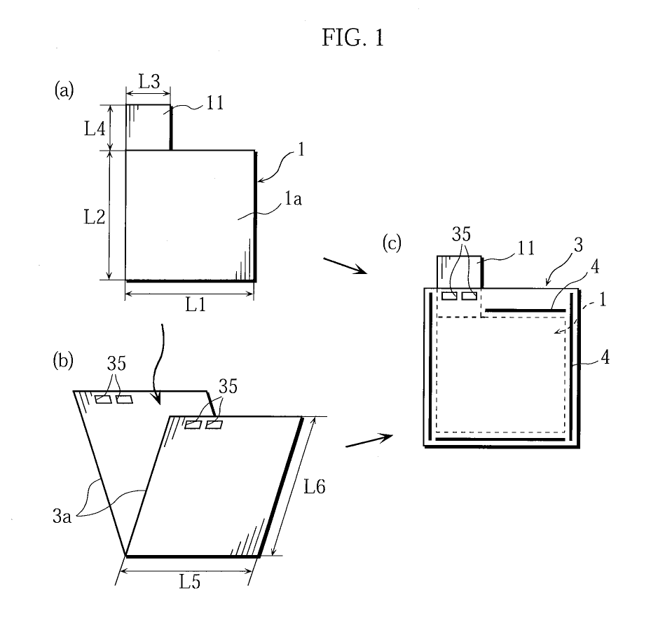

90 mass % of LiCoO₂ as a positive electrode active material, 5 mass % of carbon black as a conductive agent, and 5 mass % of polyvinylidene fluoride as a binder agent were mixed with a N-methyl-2-pyrrolidone (NMP) solution as a solvent to prepare a positive electrode mixture slurry. Thereafter, the resultant positive electrode mixture slurry was applied onto both sides of an aluminum foil (thickness: 15 μm) serving as a positive electrode current collector. Then, the material was dried to remove the solvent and compressed with rollers to a thickness of 0.1 mm. Thereafter, as illustrated in FIG. 1(a), it was cut so that a width L1=95 mm and a height L2=95 mm, to prepare a positive electrode plate 1 having a positive electrode active material layer 1a on each side. At this point, a positive electrode lead 11 was formed by allowing an active material uncoated portion having a width L3=30 mm and a height L4=30 mm to protrude from one end (the left end in FIG. 1(a)) of one side of the positive electrode plate 1 that extends widthwise.

### Preparation of Negative Electrode

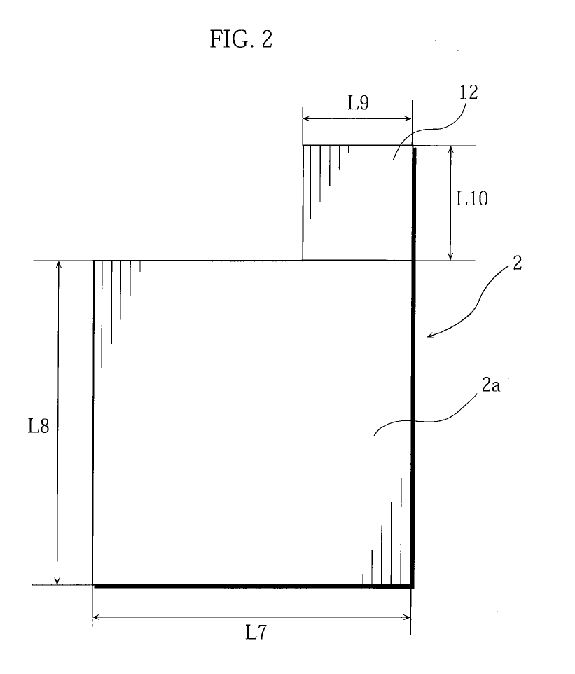

95 mass % of graphite powder as a negative electrode active material and 5 mass % of polyvinylidene fluoride as a binder agent were mixed with an NMP solution as a solvent to prepare a negative electrode slurry. Thereafter, the resultant negative electrode slurry was applied onto both sides of a copper foil (thickness: 10 μm) serving as a negative electrode current collector. Then, the material was dried to remove the solvent and compressed with rollers to a thickness of 0.08 mm. Thereafter, as illustrated in FIG. 2, it was cut so that a width L7=100 mm and a height L8=100 mm, to prepare a negative electrode plate 2 having a negative electrode active material layer 2a on each side. At this point, a negative electrode lead 12 was formed by allowing an active material uncoated portion having a width L9=30 mm and a height L10=30 mm to protrude from one end (the right end in FIG. 2) of the negative electrode plate 2 that is opposite to the side end thereof at which the positive electrode lead 11 was formed, in one side of the negative electrode plate 2 that extends widthwise.

Preparation of Pouch-Type Separator in which the Positive Electrode Plate is Disposed

As illustrated in FIG. 1(b), the positive electrode plate 1 was disposed between two square-shaped polypropylene (PP) separators 3a (width L5=100 mm, height L6=110 mm, and thickness 30 μm), each provided with a later-described penetrating portion 35. Thereafter, as illustrated in FIG. 1(c), the peripheral portions of the separators 3a were thermally welded at heat weld portions 4, whereby a pouch-type separator 3, in which the positive electrode plate 1 is accommodated, was prepared.

### Formation of Penetrating Portion

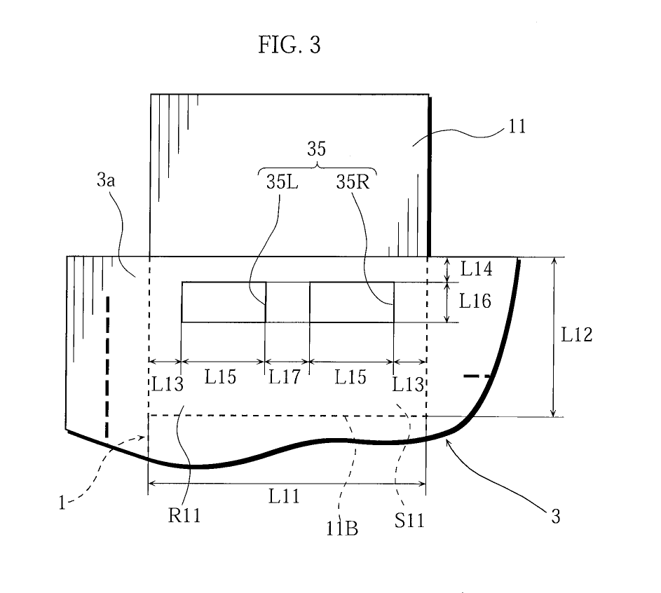

The penetrating portion 35 was provided in the pouch-type separator 3, as illustrated in FIGS. 1(b) and 1(c). Specifically, as illustrated in FIG. 3, a penetrating portion 35L shaped in a rectangular hole and having a width of L15=10 mm and a height of L16=5 mm and a penetrating portion 35R also shaped in a rectangular hole and having a width of L15=10 mm and a height of L16=5 mm were formed in two sheets of separators 3a, which constitute the pouch-type separator 3, while the positive electrode plate 1 was placed between the two sheets of separators 3a. The penetrating portion 35L was formed so as to be spaced from one side edge (the left side edge in FIG. 3) of a rectangular region R11 (i.e., a lead facing region) facing the positive electrode lead 11 and having a width of L11=L3=30 mm and a height of L12=12.5 mm, that is, from one side edge of the positive electrode lead 11, by a distance of L13=3 mm, and is also spaced from an outer side edge (the upper side edge in FIG. 3) of the lead facing region R11, that is, from an outer side edge (the upper side edge in FIG. 3) of the separator 3a by a distance of L14=2 mm. The penetrating portion 35R was formed so as to be spaced inward (rightward in FIG. 3) from the penetrating portion 35L along the width L11 (=L3) direction of the lead facing region R11 by a distance of L17=4 mm. Thus, the penetrating portion 35, comprising the two penetrating portions 35L and 35R aligned along the width L3 direction of the positive electrode lead 11, was formed in the pouch-type separator 3 at one corner portion thereof (the top left corner portion in FIGS. 1(b), 1(c), and 3) from which the positive electrode lead 11 protrudes.

It should be noted that, by constructing the pouch-type separator 3 so as to accommodate the positive electrode plate 1 therein, the lead facing region R11 is formed in each of the two sheets of the separators 3a, which constitute the pouch-type separator 3, and at the same time, a separator facing region S11 (i.e., a region of the positive electrode lead facing the separator 3a) is formed in the positive electrode lead 11. The separator facing region S11 is a rectangular region that forms within a height of L12=12.5 mm between an outer side edge (the upper side edge in FIG. 3) of the separator 3a and a positive electrode lead base edge 11B, which is the boundary between the positive electrode lead and the active material coated portion (i.e., the positive electrode active material layer 1a) of the positive electrode plate 1, and that overlaps congruently with the lead facing region R11 of each of the separators 3a.

### Preparation of Stacked Electrode Assembly

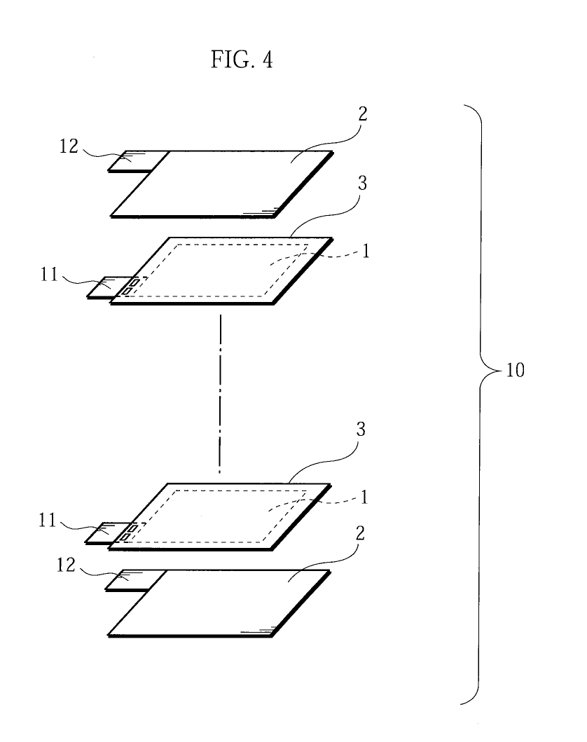

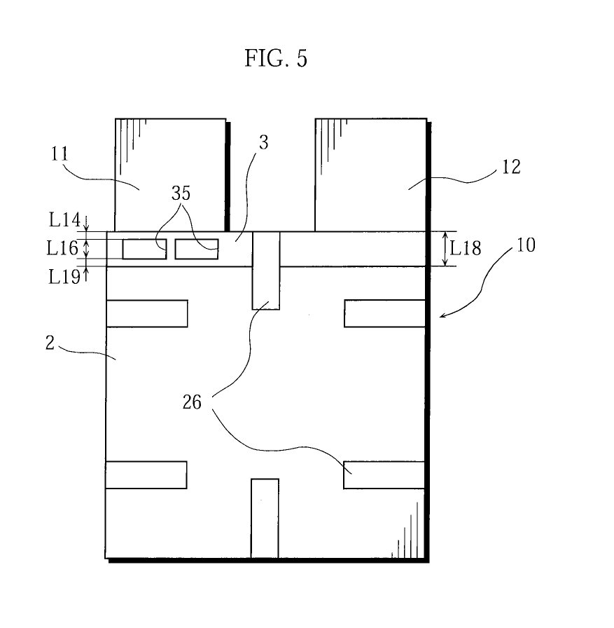

50 sheets of the pouch-type separators 3 in each of which the positive electrode plate 1 was disposed and 51 sheets of the negative electrode plates 2 were prepared, and the pouch-type separators 3 and the negative electrode plates 2 were alternately stacked one on the other, as illustrated in FIG. 4. Both top and bottom faces of the stack were the negative electrode plates 2. Subsequently, as illustrated in FIG. 5, the top and bottom faces of the stack were connected by insulating tapes 26 for retaining its shape. Thus, a stacked electrode assembly 10 was obtained.

### Welding of Electrode Plates Leads

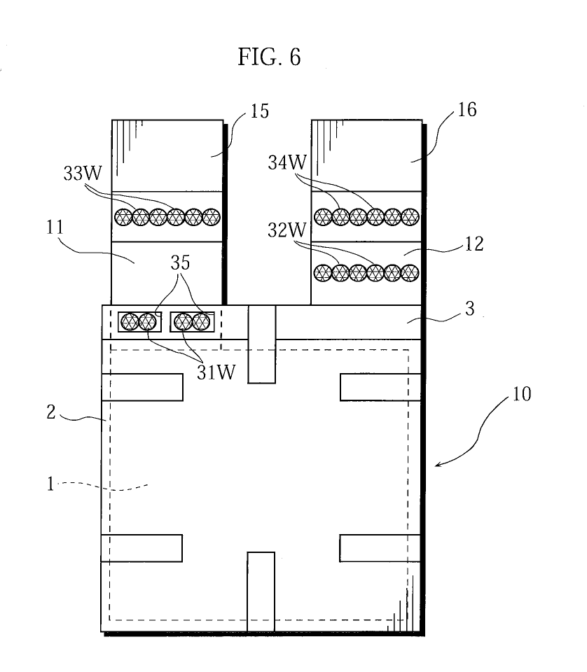

As illustrated in FIG. 6, the stacked positive electrode leads 11 were welded to each other by ultrasonic welding, and the stacked negative electrode leads 12 were likewise welded to each other by ultrasonic welding. The welding of the positive electrode leads 11 was effected through the penetrating portion 35 of the pouch-type separator 3 at weld points 31W located in the penetrating portion 35, and the welding of the negative electrode leads 12 was effected at weld points 32W located between the pouch-type separator 3 and a current collector welded portion (the welded portion with a later-described negative electrode current collector terminal 16).

### Welding of Current Collector Terminals

As illustrated in FIG. 6, a positive electrode current collector terminal 15 made of an aluminum plate having a thickness of 0.5 mm and a negative electrode current collector terminal 16 made of a copper plate having a thickness of 0.5 mm were inserted so as to be sandwiched respectively by the stacked positive electrode leads 11 and the stacked negative electrode leads 12 from their protruding ends, and they were joined at weld points 33W and 34W by ultrasonic welding.

### Placing the Electrode Assembly in Battery Case

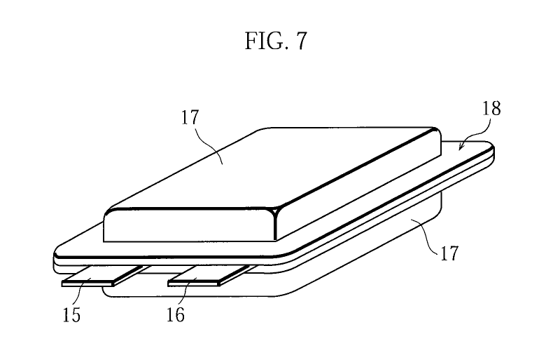

As illustrated in FIG. 7, the stacked electrode assembly 10 was inserted into a battery case 18, which had been formed of two laminate films 17 in advance so that the stacked electrode assembly 10 could be placed therein. Then, one side of the battery case in which the positive electrode current collector terminal 15 and the negative electrode current collector terminal 16 were present was thermally bonded so that only the positive electrode current collector terminal 15 and the negative electrode current collector terminal 16 would protrude from the battery case 18, and also, two sides of the remaining three sides of the battery case were thermally bonded.

### Filling Electrolyte Solution and Sealing

An electrolyte solution was prepared by dissolving LiPF₆ at a concentration of 1 M (mol/L) in a mixed solvent of 30:70 volume ratio of ethylene carbonate (EC) and methyl ethyl carbonate (MEC). The electrolyte solution was filled into the battery case 18 from the remaining one side of the battery case that was not yet thermally bonded. Lastly, the one side that had not been thermally bonded was thermally bonded. Thus, a battery was prepared.

### Advantages of the Present Invention Battery

The battery described in the foregoing embodiment (hereinafter referred to as the battery A of the invention) is a stack type battery having the following configuration. 50 sheets of the positive electrode plate 1 and 51 sheets of the negative electrode plate 2 are alternately stacked one on the other with the separators 3a interposed therebetween, and the positive electrode leads 11 and the negative electrode leads 12 protruding from the respective electrode plates 1, 2 are stacked and joined respectively to the positive electrode current collector terminal 15 and the negative electrode current collector terminal 16. Substantially the entire peripheral portions of a pair of the separators 3a facing each other across the positive electrode plate 1, except for the lead facing region R11, are firmly bonded to each other at the heat weld portions 4 by thermal welding to form the pouch-type separator 3. The positive electrode leads 11 are joined to each other in a region S11 facing the separators 3a (separator facing region).

With the above-described configuration of the battery A of the invention, if the separator 3a undergoes thermal shrinkage near the positive electrode leads 11, the separator 3a engages with the joined part of the positive electrode leads 11 (i.e., the weld points 31W located in the penetrating portion 35) and the shrinkage stops, because the positive electrode leads 11 are joined to each other in the separator facing region S11. As a result, the short circuit resulting from the contacting between the positive electrode leads 11 and the negative electrode plates 2 can be prevented effectively. Moreover, this can be achieved by merely joining the positive electrode leads 11 to each other at the separator facing region S11. Therefore, the actual size of the separator 3a is not increased, and the cross-sectional area of the positive electrode lead 11 is not reduced. As a result, the volumetric energy density of the battery is not reduced, and the internal resistance is not increased either. Thus, a mechanism for preventing a short circuit between the positive electrode leads 11 and the negative electrode plates 2 with a simple configuration is provided easily.

In the configuration of the battery A of the invention, the positive electrode plate 1 has a width of L1=95 mm and a height of L2=95 mm, and the pouch-type separator 3 has a width L5 of =100 mm and a height of L6=110 mm. Thus, both side edge portions and the lower edge portion of the peripheral portion of the pouch-type separator 3 protrude outward from the positive electrode plate 1 by a width of 2.5 mm, and each of these protruding portions serves as a weld margin (welding space) for the thermal welding. The upper edge portion, however, protrudes by 12.5 mm, 10.0 mm greater than the other edge portions, for the purpose of forming the penetrating portion 35. It should be understood that this does not substantially increase the size of the pouch-type separator 3. That is, the upper edge portion of the pouch-type separator 3 is allowed to protrude further than the other edge portions by 10 mm, in order to ensure the space for joining the positive electrode leads 11 to each other in the separator facing region S11. On the other hand, the dimensional change of the separator resulting from the thermal shrinkage does not fall within such a margin, so if the separator needs to be provided with an extra margin for allowing the thermal shrinkage, it is necessary to increase the margin of the separator by at least about 20 mm.

In addition, each of the separators 3a has the penetrating portion 35 provided in the lead facing region R11, and the positive electrode leads 11 are joined to each other in the penetrating portion 35.

It may be possible to join the positive electrode leads to each other together with the separator at the separator facing region by using, for example, laser welding (i.e., the separator is joined while being melted). However, in the battery A of the invention, by providing the penetrating portion 35 in each of the separators 3a and joining the positive electrode leads 11 to each other at the penetrating portion 35 as described above, the positive electrode leads 11 are joined to each other without interposing the separator 3a partially in the area of the separator facing region S11. This enables to use ultrasonic welding for the joining.

As the method of joining the positive electrode leads 11, it is possible to employ resistance welding or the like, other than the laser welding and the ultrasonic welding. Moreover, other than welding, it is also possible to employ a method in which the components to be joined are mechanically joined, such as screw-fastening as well as swaging and thrust-and-press clamping, in which the components to be joined are deformed. These mechanical methods offer additional advantages that the joining work can be performed with a simple facility and accordingly the fabrication of the battery can be performed more easily and at lower cost. However, in the battery A of the invention, welding is used and therefore the resistance is made more uniform. In particular, because ultrasonic welding is used, high welding strength and good weldability are obtained.

In addition, only the positive electrode leads 11 are joined to each other in the separator facing region S11 that is different from the region in which 50 sheets of the positive electrode lead 11 are stacked and joined to the positive electrode current collector terminal 15.

Generally, the number of the stacks in the stack type battery has been increased in order to obtain higher capacity, and the current collector terminals have been made thicker in order to pass larger current. This means that a large number of electrode plate leads each made of a metal foil needs to be joined to a current collector terminal made of a thick metal plate. In this case, the joined part between the metal foils and the metal plate tends to have poorer weldability than the joined part between the metal foils because of the thickness difference. When the weldability becomes poor, the connection resistance between each of the electrode plates and the current collector terminal becomes non-uniform, causing variations in the current values flowing into the respective electrode plates especially when used at high rate. As a consequence, uneven charge-discharge states arise and overdischarge and overcharge occur locally in the battery, deteriorating the cycle performance.

In contrast, in the battery A of the invention, the positive electrode leads 11 are joined and electrically connected to each other at a different location (the weld points 31W within the penetrating portion 35) from the connection portion (the weld points 33W) with the positive electrode current collector terminal 15. Therefore, variations in the resistance values of the connection portions between the positive electrode plates 1 and the positive electrode current collector terminal 15 are inhibited. Moreover, by allowing the joining of the positive electrode plate leads 11 to each other to be effected within the separator facing region S11 of the positive electrode lead 11, the battery A of the invention inhibits variations in the resistance values of the connection portions between the positive electrode plates 1 and the positive electrode current collector terminal 15, and at the same time, it effectively prevents the short circuit resulting from the contact between the positive electrode leads 11 and the negative electrode plates 2. In other words, by joining only the positive electrode leads 11 in the separator facing region S11, the battery A of the invention achieves both the effect of prevention of the short circuit between the positive electrode leads 11 and the negative electrode plates 2 and the effect of uniformization of the resistance values of the connection portions between the positive electrode plates 1 and the positive electrode current collector terminal 15.

Furthermore, the battery A of the invention is constructed by a lithium-ion battery in the form of stack type battery, and the number of the positive electrode plates 1 stacked is large, 50. Because of this, variations in the connection resistance tend to occur easily with the conventional configurations. Thus, the battery A of the invention has a configuration such that the effect of the connection resistance uniformization obtained by joining only the positive electrode leads 11 to each other in the separator facing region S11 is exhibited more significantly.

In addition, when the number of the positive electrode plates stacked is 30 or greater, the weldability of the joining portion of the current collector terminal and the positive electrode leads tends to be poorer. Therefore, the effect of the connection resistance uniformization obtained by joining only the positive electrode leads 11 to each other in the separator facing region S11 is exhibited particularly significantly in the present invention battery A, which has 50 stacks of the positive electrode plates 1.

### Other Embodiments

(1) In the battery A of the invention, only the positive electrode leads 11 are joined to each other in the separator facing region S11 that is different from the region in which the positive electrode leads 11 are joined to the positive electrode current collector terminal 15. However, it is also possible to join the positive electrode leads to the positive electrode current collector terminal in the separator facing region. This allows the joining to be effected only in the separator facing region and makes it possible to eliminate (or reduce in size of) the other portion of the positive electrode lead, so the positive electrode lead may be decreased in size correspondingly. In addition, since the joining of the positive electrode leads only to each other can be eliminated, the number of process steps can be reduced correspondingly. Nevertheless, from the viewpoint of uniformizing the connection resistance, it is desirable that only the positive electrode leads 11 be joined to each other in the separator facing region S11 that is different from the region in which the positive electrode leads 11 are joined to the positive electrode current collector terminal 15 as in the battery A of the invention. Particularly when the number of stacks is greater, it becomes more effective to join the positive electrode leads 11 only to each other in the separator facing region S11.

(2) In the battery A of the invention, almost the entire peripheral portions of the pouch-type separator 3 are thermally welded to each other at the heat weld portions 4, except for the lead facing region R11 facing the positive electrode lead 11. As a result, the thermal shrinkage of the separator 3a is inhibited by the heat weld portions 4, except in the lead facing region R11. Therefore, it is not particularly necessary to employ the same joining structure as in the case of the positive electrode leads 11 for the negative electrode leads 12. In fact, in the battery A of the invention, the welding of the negative electrode leads 12 only to each other is effected at the weld points 32W, which are located between the pouch-type separator 3 and the current collection weld portion (the weld portion to the negative electrode current collector terminal 16), not in the separator facing region. However, when the same joining structure as in the case of the positive electrode leads 11 is also employed for the negative electrode leads, i.e., when the negative electrode leads are joined to each other in the separator facing region, the pouch-type separator is also fixed by the joined part of the negative electrode leads to each other near the negative electrode leads, so the effect of preventing the misalignment more reliably can be obtained. In addition, when the joining of the negative electrode leads to each other is effected in the separator facing region, the length or size of the negative electrode lead can be reduced correspondingly. Particularly when the negative electrode leads are joined also to the negative electrode current collector terminal in the separator facing region as in the case of the positive electrode illustrated in the above-described (1), the size of the negative electrode lead can be made even smaller.

(3) In the battery A of the invention, the pouch-type separator 3 has a configuration in which the heat weld portions 4 are welded linearly along the peripheral portion. However, the pouch-type separator may be any type of separator as long as it can hold a positive electrode plate between a plurality of separator sheets. In addition to the one in which separators are firmly bonded to each other at each of their three or four sides linearly to form a pouch, as in the battery A of the invention, it is possible to use one in which separators are firmly bonded to each other at least one point in each of their three or four sides. Needless to say, in order to prevent the positive electrode plates and the negative electrode plates from contacting reliably, it is desirable that the unbonded portion of the pouch-type separator be as small as possible. In addition, the method for firmly bonding the separators is not particularly limited, and it is possible to use an appropriate fastening member (e.g., snap hook-type member) that is provided separately, other then thermal welding. It is also possible to employ a configuration in which the separators are folded over at least one side.

In the battery A of the invention, a weld margin (welding space) with a width of 2.5 mm (or 12.5 mm) is provided along the peripheral portion of the pouch-type separator 3, as described above. It is desirable that the bonding margin (bonding space) in the separator be from 1 mm to 5 mm, more preferably 2 mm to 3 mm, for example. If the bonding margin (bonding space) is less than 1 mm, the bonding becomes difficult, and moreover, the margin for allowing misalignment of the positive and negative electrode plates is too small because the difference in the sizes of the positive electrode plate and the negative electrode plate is two small. On the other hand, if the bonding margin (bonding space) is greater than 5 mm, the bonding margin (bonding space) is exceedingly large, so the size of the positive electrode plate is reduced relatively. As a consequence, the volumetric energy density of the battery decreases unduly.

(4) In the battery A of the invention, the penetrating portion 35 comprising two penetrating portions 35L and 35R aligned along the width L3 direction of the positive electrode lead 11 is formed in the pouch-type separator 3. However, the configuration of the penetrating portion may be any other type as long as it allows the positive electrode leads to be joined to each other and permits the separator to be engaged with the joined part of the positive electrode leads when the separator undergoes thermal shrinkage. Taking the number of process steps into consideration, an appropriate number of the penetrating portions should be about from 2 to 3 in the case where the positive electrode lead 11 has a width of L3=30 mm as in the battery A of the invention, although it may depend on the size (width) of the positive electrode lead. Nevertheless, it is possible to form one oblong penetrating portion extending along the width direction of the positive electrode lead as long as the surrounding portion of the penetrating portion is ensured to have a mechanical strength that is resistant to breaking due to thermal shrinkage, so that the number of process steps can be further reduced.

As illustrated in FIG. 3, in the battery A of the invention, the distance L14 between the penetrating portions 35L, 35R and the outer side edge (the upper side edge in FIG. 3) of the separator 3a is 2 mm, and the distance L17 between the penetrating portion 35L and the penetrating portion 35R is 4 mm. In addition, even greater distances are ensured between both side edges of the separator 3a and the respective sides of the penetrating portions 35L and 35R. However, it is sufficient that the width of the surrounding portion of the penetrating portion be within the range in which a mechanical strength resistant to breaking resulting from the thermal shrinkage is ensured. Specifically, although it may depend on the size of the penetrating portion, the thickness of the separator, the material of the separator, and the like, it is desirable that the width of the surrounding portion of the penetrating portions 35L and 35R, including the distance L14 between the outer side edge of the separator 3a and the penetrating portion 35L, 35R, be greater than 1 mm, more desirably equal to or greater than 2 mm, when each of the penetrating portions 35L and 35R have a rectangular shape with a width of L15=10 mm and a height of L16=5 mm and the separator 3a is made of polypropylene (PP) with a thickness of 30 μm, as in the case of the battery A of the invention.

Furthermore, it is sufficient that the size of the penetrating portion be within the range in which the positive electrode leads are joined to each other therein. However, if the distance between the penetrating portion and the weld points therein is too small, the welding work becomes difficult. Moreover, if the size of the penetrating portion is unnecessarily large, the size of the separator needs to be increased excessively since the penetrating portion cannot be formed in the location in which the negative electrode exists. For this reason, it is desirable that the size of the penetrating portion be within a range such as to ensure that the distance between the penetrating portion and the weld point therein is about 2 mm to about 5 mm.

In the configuration of the battery A of the invention, as illustrated in FIG. 5, the negative electrode plate 2 is shorter than the pouch-type separator 3 by L18=10 mm in the side on which the positive and negative electrode leads 11 and 12 are formed (the upper side in FIG. 5). The distance L14 between the side edge in that side of the pouch-type separator 3 (the upper side in FIG. 5) and the penetrating portions 35L and 35R is set at 2 mm, and the height L16 of the penetrating portions 35L and 35R is set at 5 mm. Therefore, a distance L19 of 3 mm is ensured between the negative electrode plate 2 and the penetrating portions 35L, 35R. However, it is sufficient that the penetrating portion be formed and disposed at such a location that the penetrating portion does not reach (overlap) the negative electrode plate. Nevertheless, it is desirable that a distance of about 2 mm to about 5 mm be ensured between the penetrating portion and the negative electrode plate. If this distance is equal to or greater than 2 mm, the penetrating portion will not reach the negative electrode plate even when some shrinkage, deformation, or the like occurs. If the distance is equal to or less than 5 mm, the size of the separator will not be increased unduly.

(5) The positive electrode active material is not limited to the LiCoO₂, but may be other substances, such as LiNiO₂, LiMn₂O₄, and combinations thereof. Examples of the negative electrode active material that can be used suitably include natural graphite and artificial graphite.

(6) In the foregoing example, the negative electrode active material layer was formed on both sides of the negative electrode current collector for all the negative electrode plates 2. However, the negative electrode active material layers in the portions that do not face the positive electrode plates (specifically, the negative electrode active material layers on the outer sides of the outermost negative electrode plates) may be eliminated. Such a configuration allows the stacked electrode assembly to have a smaller thickness, allowing the battery to have a higher capacity density.

The present invention may be applied suitably to, for example, batteries used for such equipment as robots, electric vehicles, and backup power sources.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A stack type battery comprising:
a plurality of positive electrode plates each having a positive electrode lead protruding therefrom; a plurality of negative electrode plates each having a negative electrode lead protruding therefrom; a plurality of separators; a positive electrode current collector terminal; and a negative electrode current collector terminal, the positive and negative electrode plates being alternately stacked one on the other with the separators interposed therebetween, and the positive electrode leads and the negative electrode leads being stacked and joined respectively to the positive electrode current collector terminal and the negative electrode current collector terminal, wherein:
peripheral portions of the separators that face each other across each of the positive electrode plates are firmly bonded to each other at least a portion of each of the peripheral portions to form a pouch-shaped separator; and
the positive electrode leads are joined to each other in a region in which each of the positive electrode leads and each of the separators face each other.

2. The stack type battery according to claim 1, wherein each of the separators has a penetrating portion provided in a region thereof facing the positive electrode leads, and the positive electrode leads are joined at the penetrating portion.

3. The stack type battery according to claim 1, wherein the positive electrode leads are joined to each other in a region in which the positive electrode leads and the separators face each other, the region being different from a region in which the plurality of the positive electrode leads are stacked and joined to the positive electrode current collector terminal.

4. The stack type battery according to claim 2, wherein the positive electrode leads are joined to each other in a region in which the positive electrode leads and the separators face each other, the region being different from a region in which the plurality of the positive electrode leads are stacked and joined to the positive electrode current collector terminal.
